(19) United States
(12) Patent Application Publication
(10) Pub. No.: US 2011/0126423 A1
(43) Pub. Date: Jun. 2, 2011

(54) Elastic Structure Made by Plastic Injection Molding

(76) Inventor: Teng-Jen YANG, Taichung County (TW)

(21) Appl. No.: 12/646,973

(22) Filed: Dec. 24, 2009

(30) Foreign Application Priority Data
Dec. 2, 2009 (TW) 098141174

(51) Int. Cl. A43B 13/20; B32B 37/22

(52) U.S. Cl. 36/29; 156/242

(57) ABSTRACT

An elastic structure made by plastic injection molding comprises an elastic body and a connecting member. The elastic body includes two oppositely-connected half members which are made by plastic injection molding. The connecting member is formed around the circumference of the elastic body by injection molding and seals the two half members. While the connecting member is formed by injection molding, gas will be filled into the elastic body to make the elastic body have buffer elasticity. The half members made by plastic injection molding can be changed in shape as desired by changing the mold and can be formed with a mark portion with a brand slogan or mark during the plastic injection molding, thus making the production more convenient while controlling the yield. Furthermore, the application range of the elastic structure can be widened since the elastic structure can be made into different shapes.

### BACKGROUND OF THE INVENTION

1. Field of the Invention

The present invention relates to an elastic structure, and more particularly to an elastic structure made by plastic injection molding.

2. Description of the Prior Art

A conventional elastic structure disposed on a shoe bottom comprises plural buffer air chambers formed by blow molding to offer a buffer function, however, the buffer air chambers are formed by blow molding, the quality of the buffer air chambers depends on the air pressure which is difficult to control, so that it is unable to effectively control the size and the product yield of the buffer air chambers formed by blow molding, thus consequentially increasing the shoe cost. In addition, the blow molding process will produce much edge waste most of which cannot be recycled, thus increasing the material cost while wasting source, which is neither environment-friendly and nor energy-saving.

Furthermore, the thickness of the buffer air chamber formed by blow molding is controlled by the air pressure, but thickness uniformity of the buffer air chamber cannot be exactly controlled, so the buffer air chamber cannot be used to control the direction of the force of the shoe, making it impossible to produce shoes for different purposes. In addition, since the buffer air chamber is formed by blow molding, coating is the only way when it comes to putting a trademark or color on the buffer air chamber, which not only requires an extra work process but increases manufacturing cost. In addition, the color will fade away after the buffer air chamber is used for a period of time, thus causing cost and material waste.

The present invention has arisen to mitigate and/or obviate the afore-described disadvantages.

### SUMMARY OF THE INVENTION

The primary objective of the present invention is to provide an elastic structure made by plastic injection molding which can improve the product yield and widen the product application range.

In order to achieve the above objective, an elastic structure formed by plastic injection molding in accordance with the present invention comprises an elastic body and a connecting member.

The elastic body includes two oppositely-connected half members, and each of the half members includes an inner surface and an outer surface and is formed with a connecting edge which is formed around a circumference of the half member. The connecting edges extend outwards from the respective half members, and one of the half members is interiorly defined with an accommodation space. The two half members are disposed in such a manner that the two inner surfaces of the two half members are oppositely arranged, and the connecting edges abut against each other. The respective half members are made by plastic injection molding.

The connecting member is made by injection molding to connect the connecting edges of the two half members.

While the connecting member is made by injection molding, the gas produced by the injection molding of the connecting member can be filled into the elastic body to make the elastic structure have elasticity to offer a buffer function. The half members are also made by injection molding, so that the shape and the thickness of the half members can be controlled by changing the mold, thus not only making the production convenient but improving the product yield and widening the application range.

### BRIEF DESCRIPTION OF THE DRAWINGS

FIG. 1 is an exploded view of an elastic structure made by plastic injection molding in accordance with the present invention;

FIG. 2 is a cross-sectional view showing that the elastic body formed by injection molding is disposed in a mold to form the connecting member;

FIG. 3 is a perspective view of the elastic structure made by plastic injection molding;

FIG. 4 is a cross-sectional view of the elastic structure made by plastic injection molding;

FIG. 5 is a perspective view showing that the elastic structure made by plastic injection molding in accordance with the present invention is applied to a shoe;

FIG. 6 is a plane view showing that the elastic body made by injection molding is formed into a different shape;

FIG. 7 is a cross-sectional view of the elastic structure of FIG. 6;

FIG. 8 is a cross-sectional view showing that the elastic body of the elastic structure made by plastic injection molding is in another shape;

FIG. 9 is a cross-sectional view showing that the elastic body of FIG. 8 is applied to a shoe;

FIG. 10 is cross-sectional view of an elastic structure made by plastic injection molding in accordance with another embodiment of the present invention;

FIG. 11 is a cross section view of a mod for forming the connecting member of FIG. 10;

FIG. 12 is a perspective view showing that the elastic structure made by injection molding in accordance with the present invention is formed with a mark portion; and

FIG. 13 is a cross-sectional view showing that the half members of the elastic structure made by plastic injection molding have non-uniform thickness.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

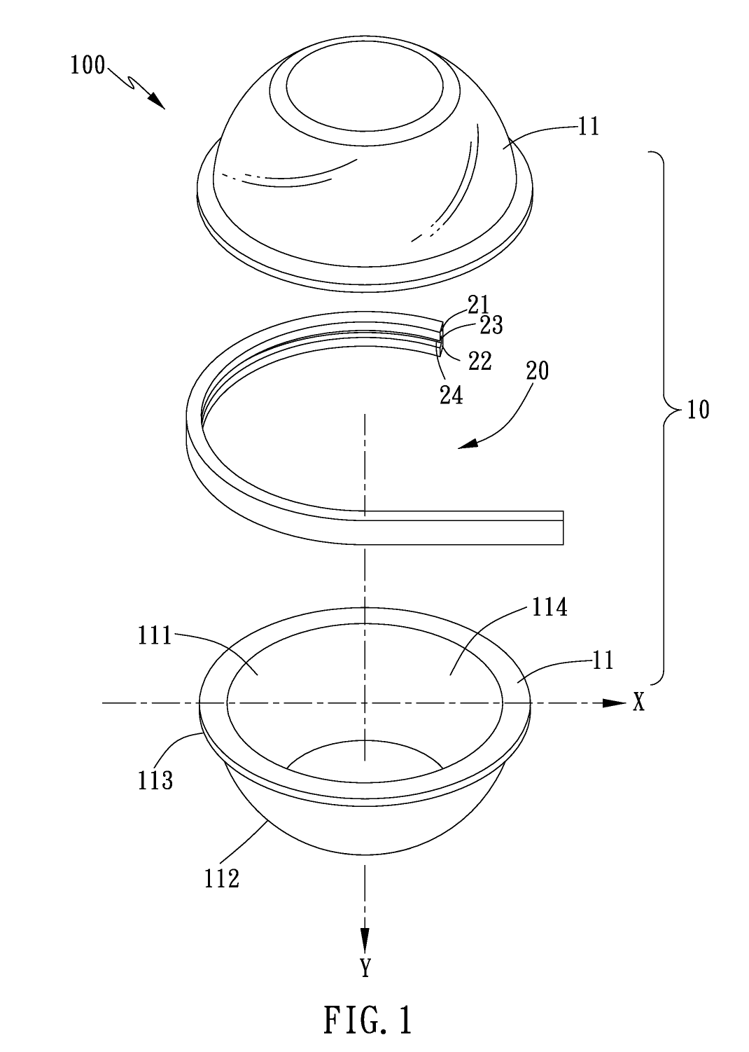

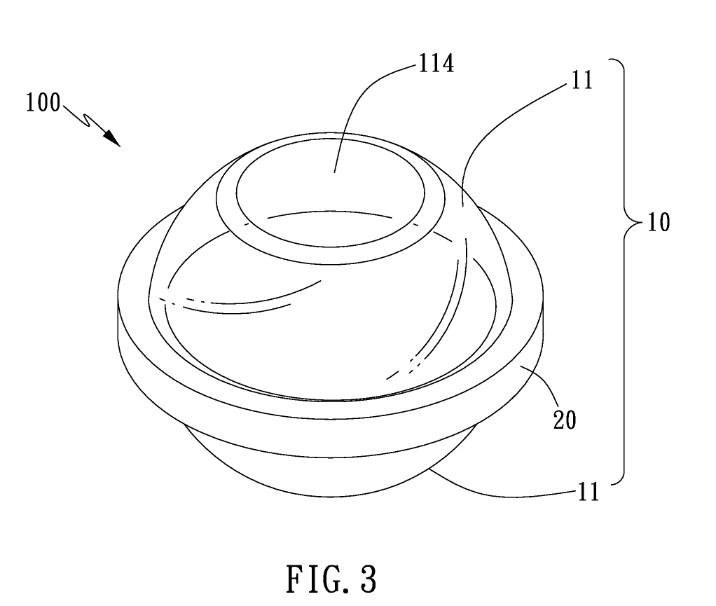

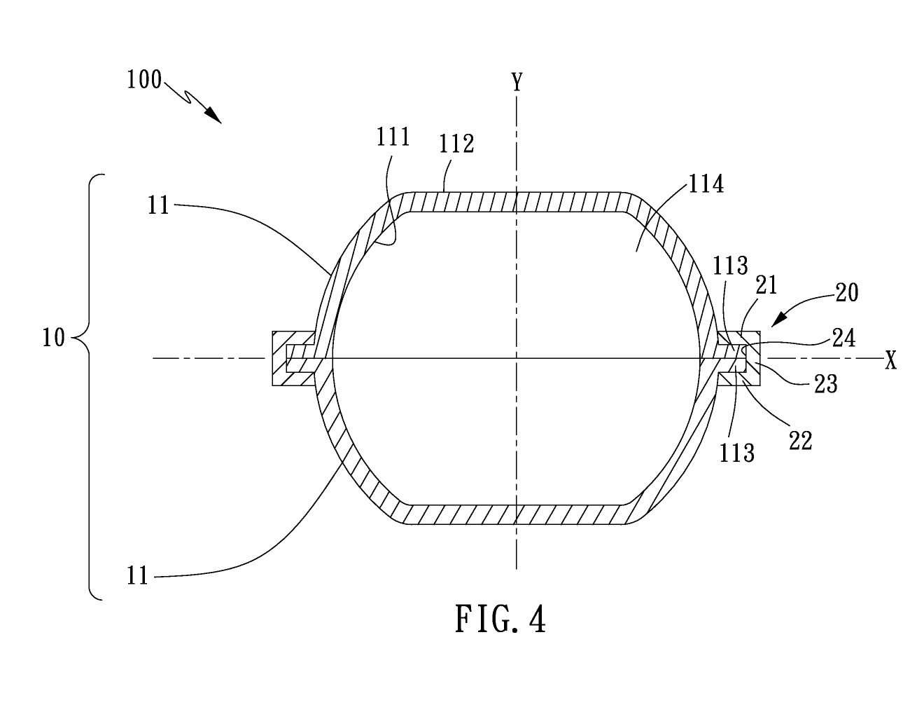

Referring to FIGS. 1-5, an elastic structure 100 in accordance with a preferred embodiment of the present invention comprises an elastic body 10 and a connecting member 20.

The elastic body 10 includes two oppositely-connected half members 11. Each of the half members 11 in the present embodiment is a hollow semi-spherical structure made by plastic injection molding and includes an inner surface 111, an outer surface 112, and a connecting edge 113 which is formed at a connection between the inner surface 111 and the outer surface 112 and located around a circumference of the half member 11. The connecting edge 113 extends outwards from the half member 11, and the extending direction of the connecting edge 113 is defined as a horizontal direction X. A direction vertical to the horizontal direction X is defined a longitudinal direction Y, and each of the half members 11 is interiorly defined with an accommodation space 114 in the longitudinal direction Y. The two half members 11 are disposed in such a manner that the two inner surfaces 111 of the two half members 11 are oppositely arranged, the accommodation spaces 114 of the two half members 11 are in communication with each other, and the two connecting edges 113 abut against each other.

The connecting member 20 is integrally formed and includes an upper portion 21, a lower portion 22 and a lateral portion 23 which connects the upper portion 21 and the lower portion 22. The upper portion 21 and the lower portion 22 cooperate with the lateral portion 23 to define a clamping opening 24 for enclosing the connecting edges 113 of the two half members 11 and sealing the elastic body 10, namely sealing the accommodation spaces 114 of the two half members 11 of the elastic body 10. By such arrangements, the elastic structure 100 is formed into a sealed hollow spherical structure.

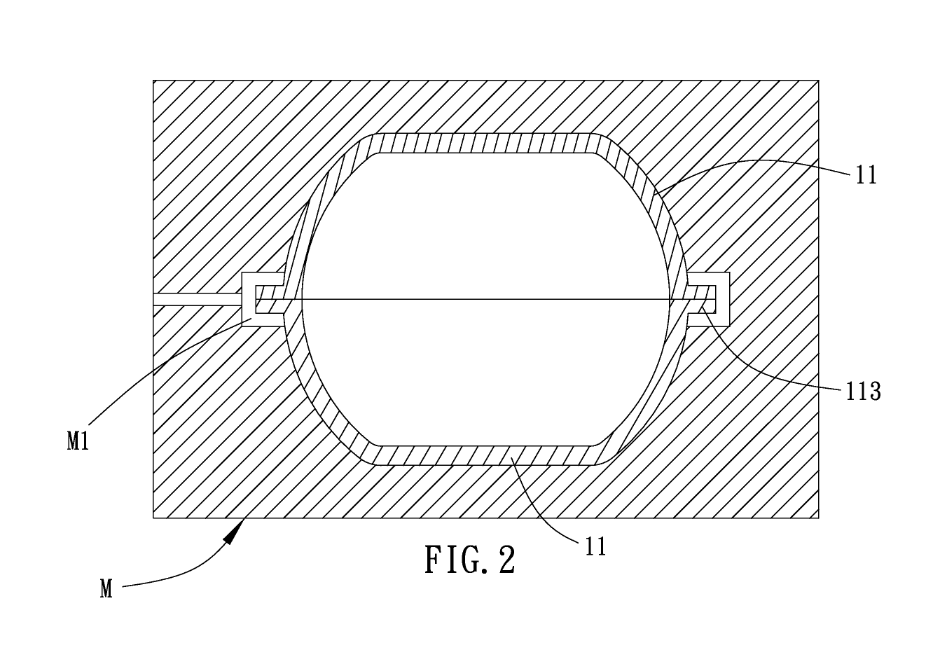

The connecting member 20 is formed around the outer periphery of the connecting edges 113 of the elastic body 10 by plastic injection molding. Before the connecting member 20 is formed, as shown in FIG. 2, the two connecting members 11 of the elastic body 10 will be oppositely combined and disposed in a mold M which is defined with a molding space M1 for forming the connecting member 20, and next, the plastic will be melt by heating and then injected into the molding space M1 of the mold M to form the connecting member 20 which will seal the two half members 11. The molding space M1 is formed correspondingly to the connecting edges 113 of the two half members 11, so that before the plastic is formed around the outer periphery of the connecting edges 113 of the elastic body 10, the gas produced by the plastic will enter the accommodation spaces 114 of the two half members 11 of the elastic body 10 through the molding space M1, at the same time, the plastic will be injected into the molding space M1 to enclose the connecting edges 13 of the elastic body 10 and then seal the two half members 11 of the elastic body 10 after cooling down, namely sealing the accommodation spaces 114 in the elastic body 10. By such arrangements, the gas will be left in the accommodation spaces 114 to further increase the elasticity of the elastic structure.

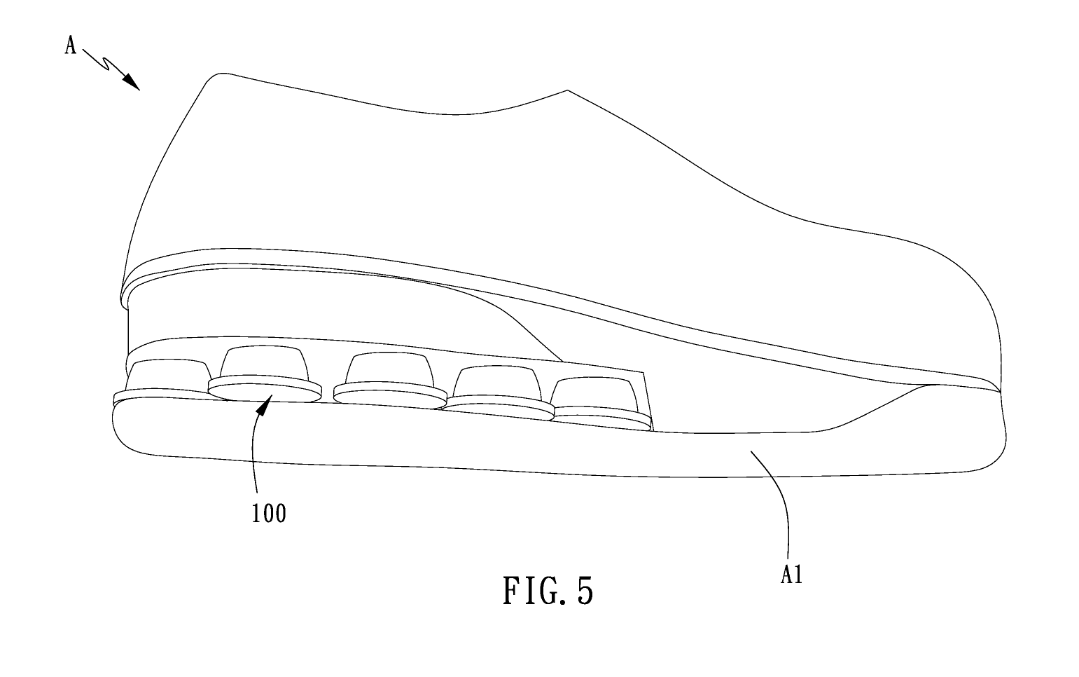

The elastic structure 100 is provided to be disposed on a shoe bottom A1 of a shoe A, as shown in FIG. 5, the shoe A is provided with plural elastic structures 100 which utilize the gas in the accommodation spaces 114 of the elastic body 10 to offer the buffer function. Since the elastic body 10 is made by plastic injection molding and includes two oppositely-connected semispherical half members 11, the half members 11 can be produced in large quantities by injection molding in advance, and the two oppositely-connected half members 11 can be different in shape but should be provided with the corresponding connecting edges 113 which can abut against each other to connect the two half members 11 oppositely and seal the two oppositely-connected half members 11. Therefore, the elastic body 10 can be shaped as desired. Further, since the respective half members 11 are made by injection molding which is a highly mature manufacturing method, the yield of the half members 11 can be controlled, the size of the elastic structure can be controlled accurately, and further the thickness of the half members 11 can be precisely controlled as desired.

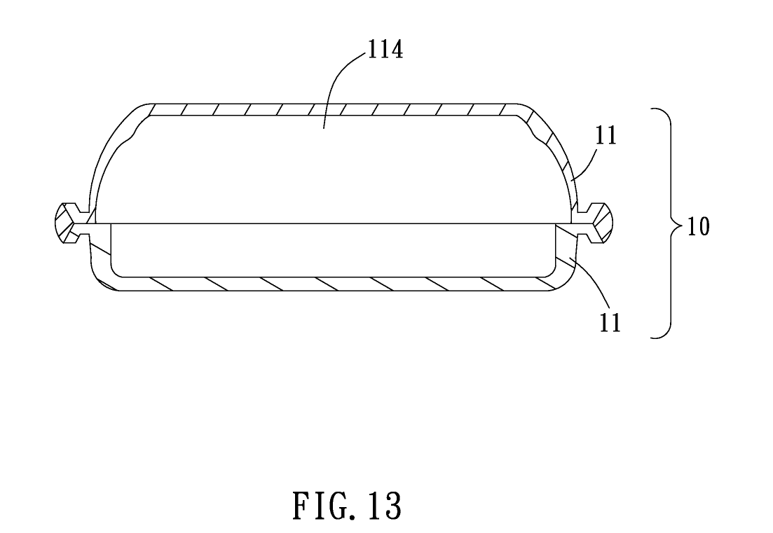

In addition, the thickness of the respective half members 11 can be changed according to the actual requirements, as shown in FIG. 13. The half members 11 having non-uniform thickness can be produced as long as the direction of the force and the required shape are determined. With the half members 11 having the non-uniform thickness, the elastic structure 100 can have elasticity in desired directions, so that it can be used to manufacture a shoe A having a special buffer function, such as jogging shoes, basketball shoes or other sports shoes, thus widening the application range of the elastic structure.

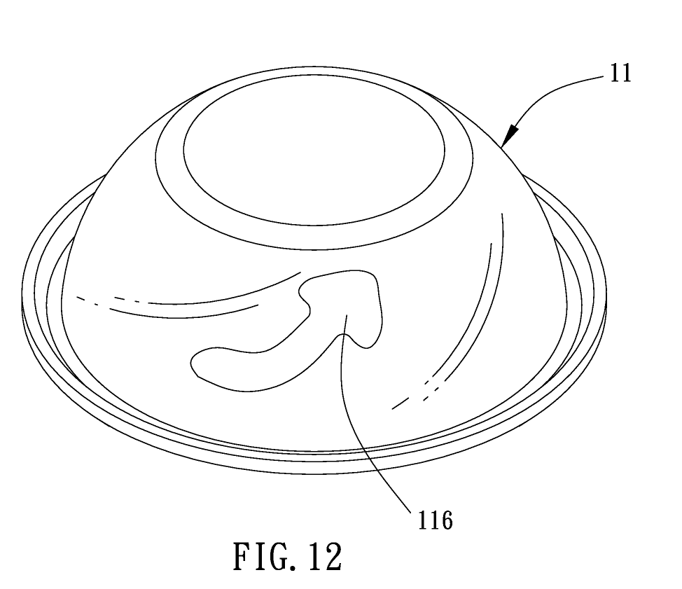

Furthermore, the mold M can be provided with a mark molding portion in advance, so that a mark portion 116 with a brand slogan or mark will be formed during the plastic injection molding of the half members 11, as shown in FIG. 12. In addition, the color of the elastic structure 100 can be changed by changing the color of the plastic directly without an extra work process, and the color of the plastic cannot fade away after a long time of use, maintaining the color durability.

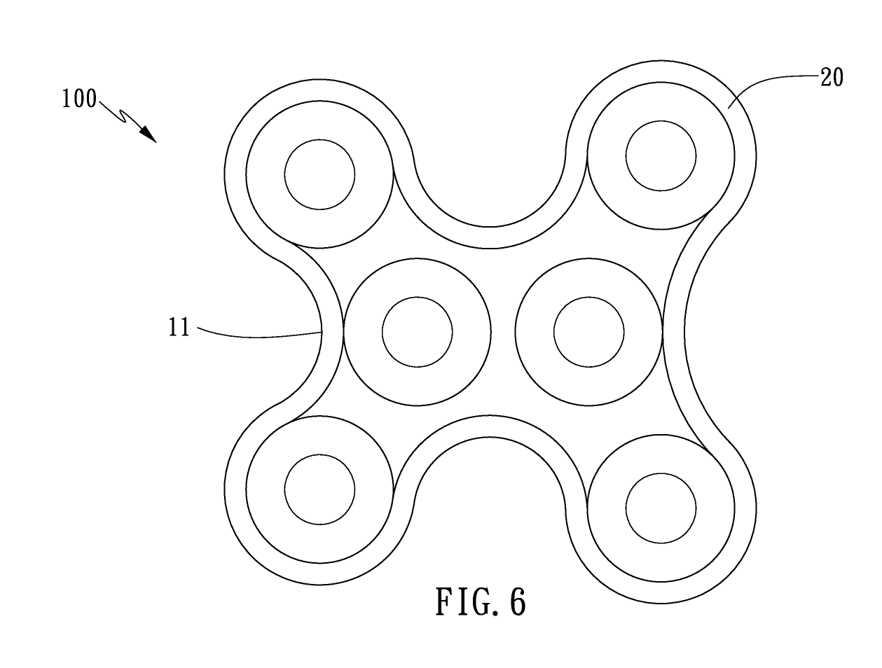

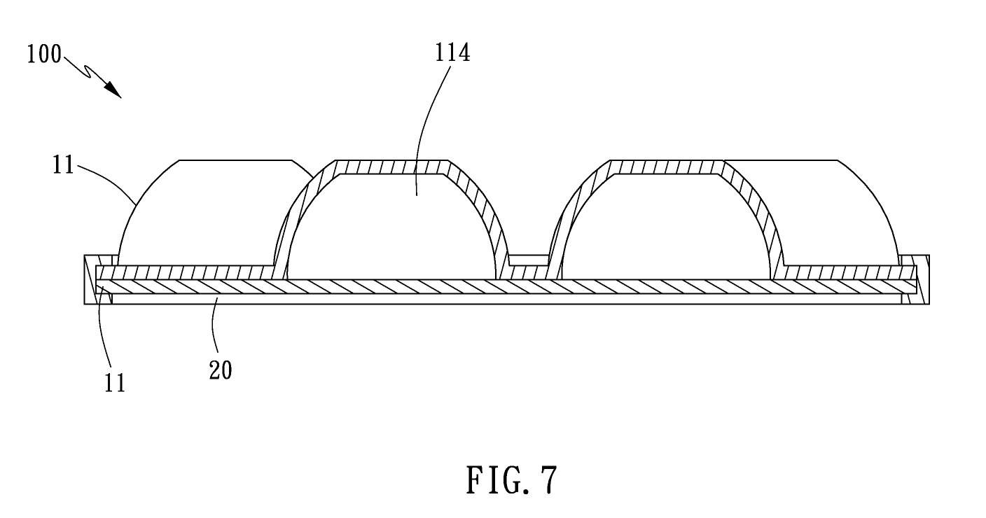

Further, the elastic structure 100 can also be formed into an irregular shape, as shown in FIGS. 6-7, and one of the half members 11 includes plural accommodation spaces 114, and the other of the half members 11 is in the shape of a plate and disposed opposite the accommodation spaces 114. The connecting member 20 will be also used to enclose the circumference of the elastic structure 100, and the accommodation spaces 114 also contain the gas. The elastic structure 100 can also offer the buffer function through the accommodation spaces 114.

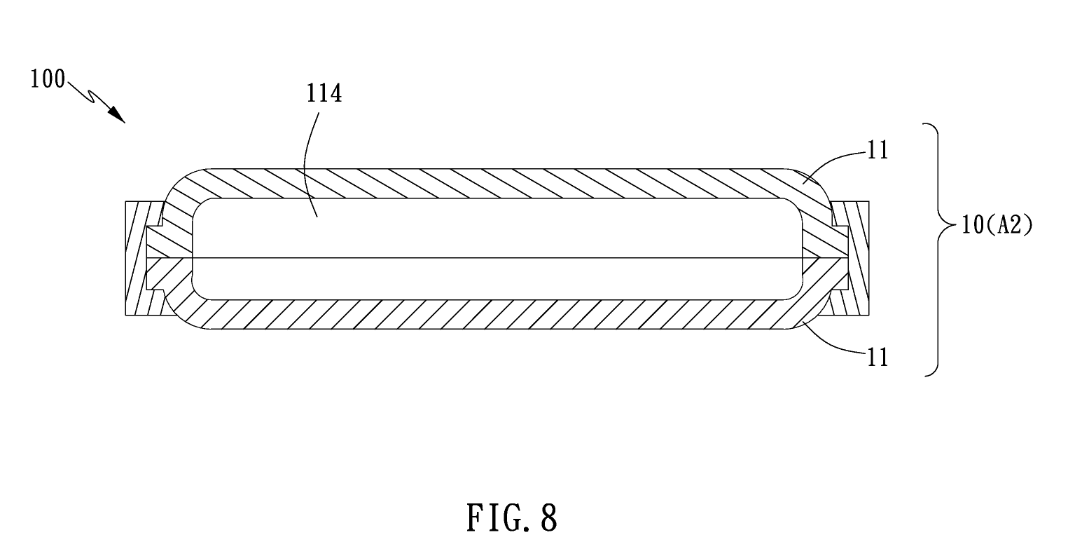

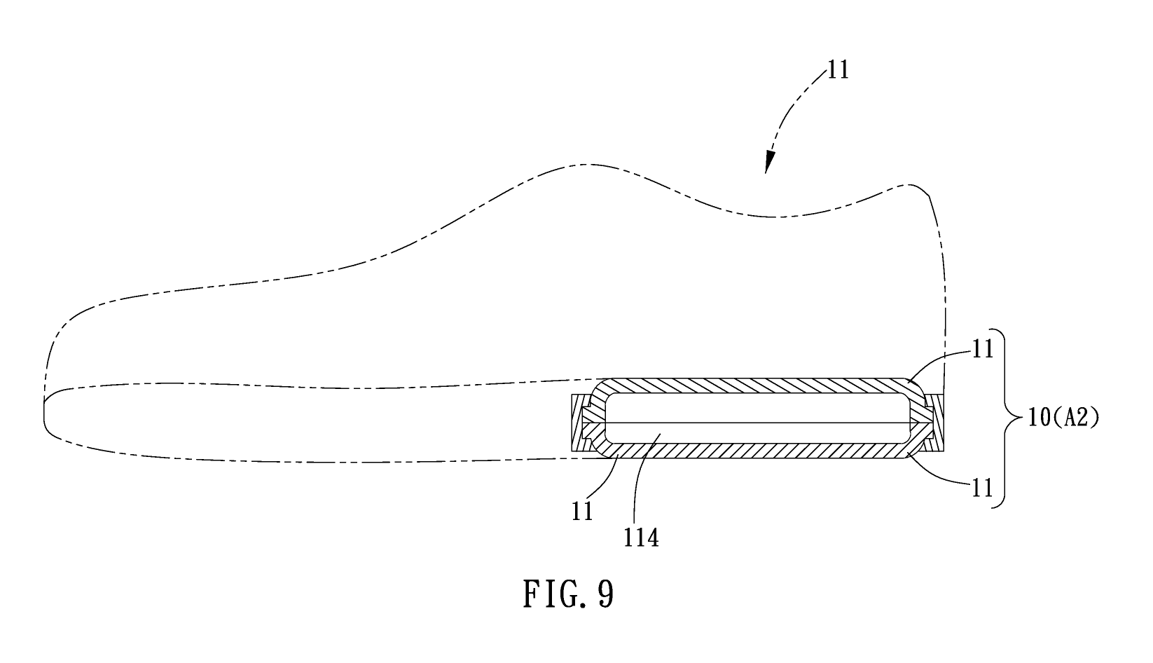

FIGS. 8-9 illustrate an elastic structure 100 in accordance with another embodiment of the present invention, the half members 11 of the elastic body 10 are formed as a portion of an outsole A2 of the shoe A, and each of the half members 11 also includes an accommodation space 114 containing gas, so that the shoe A can use the elastic body 10 as the outsole A2 to directly offer the buffer function without an additional buffer structure, facilitating production and use.

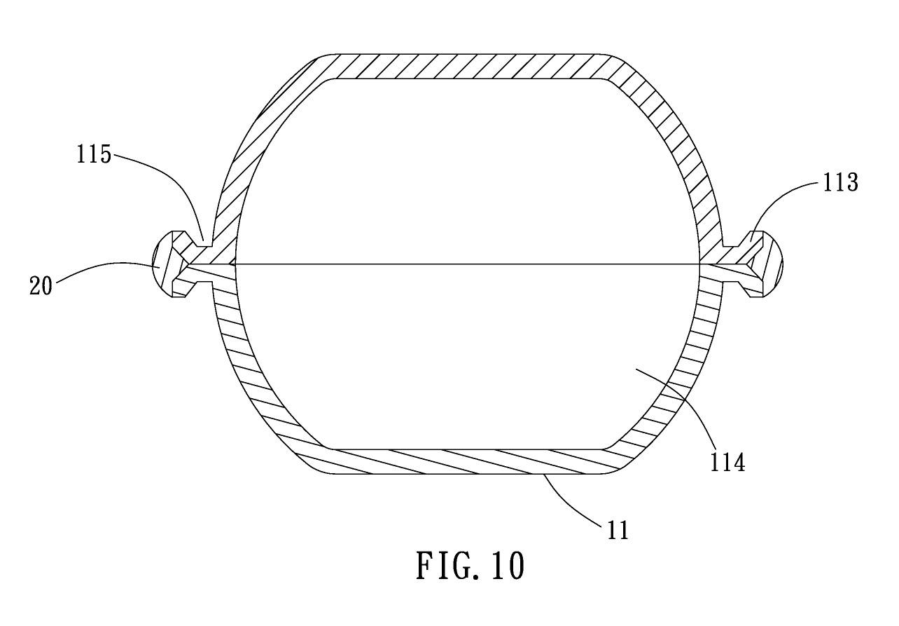

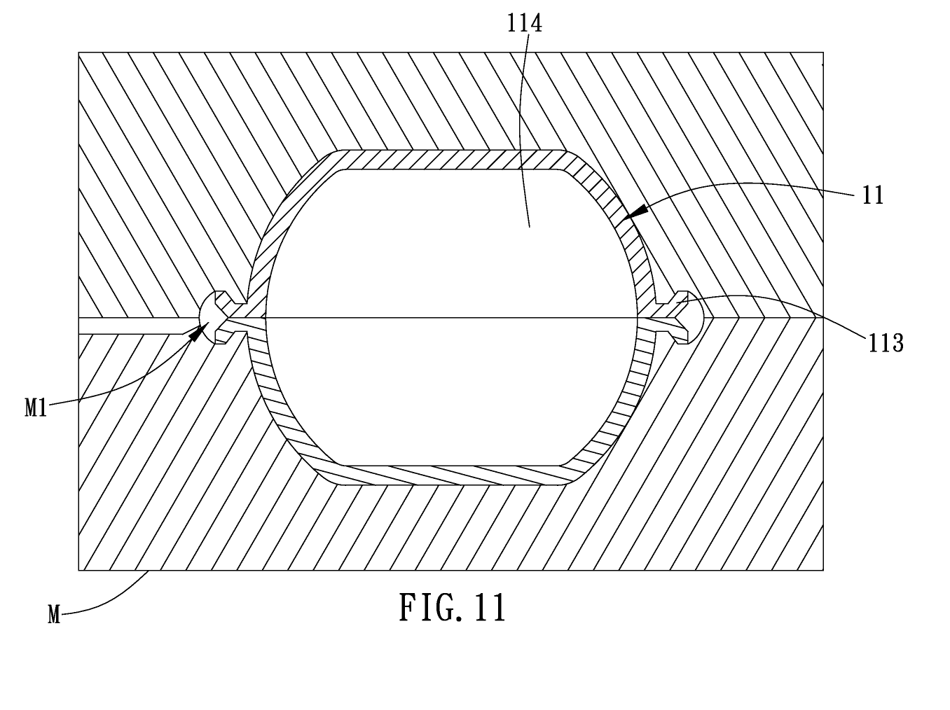

Referring to FIG. 10, in another embodiment of the present invention, the connecting member 20 is formed between the connecting edges 113 of the two half members 11, and a material blocking groove 115 is defined between the connecting edge 113 and an outer surface of each of the half members 11. The mold M for forming the connecting member 20 in the present embodiment is as shown in FIG. 11.

While we have shown and described various embodiments in accordance with the present invention, it is clear to those skilled in the art that further embodiments may be made without departing from the scope of the present invention.

What is claimed is:

1. An elastic structure made by plastic injection molding comprising:
an elastic body including two oppositely-connected half members, each of the half members including an inner surface and an outer surface and a connecting edge which is formed around a circumference of the half member, the connecting edges extending outwards from the respective half members, and one of the half members being interiorly defined with an accommodation space, the two half members being disposed in such a manner that the two inner surfaces of the two half members are oppositely arranged, and the connecting edges abut against each other, the respective half members being made by plastic injection molding; and
a connecting member being made by injection molding to connect the connecting edges of the two half members.

2. The elastic structure made by plastic injection molding as claimed in claim 1, wherein each of the two half members is a hollow semispherical structure, and the other of the half members also includes an accommodation space.

3. The elastic structure made by plastic injection molding as claimed in claim 1, wherein one of the two half members is in an irregular shape and includes plural accommodation spaces, and the other of the two half members is in the shape of a plate.

4. The elastic structure made by plastic injection molding as claimed in claim 1, wherein each of the two half members is in an irregular shape and includes plural accommodation spaces.

5. The elastic structure made by plastic injection molding as claimed in claim 1, wherein the half members of the elastic body are formed into the shape of an outsole of a shoe.

6. The elastic structure made by plastic injection molding as claimed in claim 1, wherein each of the connecting edges extends outwards from a connection between the inner surface and the outer surface of the half member.

7. The elastic structure made by plastic injection molding as claimed in claim 1, wherein an extending direction of the connecting edge is defined as a horizontal direction, and a direction vertical to the horizontal direction is defined as a longitudinal direction, the half member is defined with the accommodation space in the longitudinal direction.

8. The elastic structure made by plastic injection molding as claimed in claim 2, wherein the accommodation spaces of the two half members are in communication with each other.

9. The elastic structure made by plastic injection molding as claimed in claim 1, wherein the connecting member is integrally formed by the injection molding.

10. The elastic structure made by plastic injection molding as claimed in claim 1, wherein the connecting member makes the elastic body form a sealed hollow spherical structure.

11. The elastic structure made by plastic injection molding as claimed in claim 1, wherein the connecting member makes the elastic body form a sealed irregular structure.

12. The elastic structure made by plastic injection molding as claimed in claim 1, wherein the connecting member includes an upper portion, a lower portion and a lateral portion which connects the upper portion and the lower portion, the upper portion and the lower portion cooperate with the lateral portion to define a clamping opening for enclosing the connecting edges of the two half members.

13. The elastic structure made by plastic injection molding as claimed in claim 1, wherein the connecting member is formed between the connecting edges of the two half members.
